(19) United States
(12) Patent Application Publication
(10) Pub. No.: US 2006/0119000 A1
(43) Pub. Date: Jun. 8, 2006

(54) Composite container closure with detachable utensil

(75) Inventor: Robert W. Gibson, Chalfont, PA (US)

Correspondence Address: SYNNESTVEDT & LECHNER, LLP, 2600 ARAMARK TOWER, 1101 MARKET STREET, PHILADELPHIA, PA, 191072950, US

(73) Assignee: Double "H" Plastics, Inc., Warminster, PA (US)

(21) Appl. No.: 11/333,070

(22) Filed: Jan. 17, 2006

Related U.S. Application Data
(62) Division of application No. 10/974,652, filed on Oct. 27, 2004.
(60) Provisional application No. 60/515,344, filed on Oct. 28, 2003.

(51) Int. Cl. B29C 70/80; B29C 45/14

(52) U.S. Cl. 264/268; 264/265; 156/60

(57) ABSTRACT

A method of making a closure for a container is disclosed. The closure has a central panel surrounded by a plastic skirt. A utensil is attached to the skirt. The method includes providing a mold having a mold space that receives the central panel and defines the skirt and the utensil, positioning the panel within the mold space, injecting molten plastic into the mold space to form the skirt and the utensil, curing the plastic to form the closure and then removing the closure from the mold.

### FIELD OF THE INVENTION

This invention concerns closures for containers, and especially closures for single serving foodstuff containers having utensils provided with the closure.

### BACKGROUND OF THE INVENTION

Foodstuffs such as yogurt, ice cream, cottage cheese and the like are conveniently packaged in containers holding a single serving size. The food in such containers is intended to be consumed directly from the container as a meal or a snack. The aforementioned food items are not conveniently eaten without utensils, however, and it is found troublesome to supply a utensil, such as a spoon, with the container.

Separate utensils may be supplied along with the container at its point of purchase, or a separate utensil may be packaged on the outside of the container, but these measures do not reliably provide a utensil with a container. The utensils become separated and lost, or the supply of food containers exceeds the supply of utensils. If utensils are not supplied, the result is lost sales of a perishable product with limited shelf life.

Attempts have been made in the past to integrally mold utensils into container closures. However, such solutions have largely been confined to homogeneous plastic closures and are not readily applicable to composite closures formed of a central paperboard panel surrounded by a plastic skirt. Composite closures are in widespread use for their ability to be substantially sealingly re-closed after opening. Furthermore, composite closures are advantageous because the paperboard panel in such closures provides a large surface area that may be printed with colorful indicia such as trademarks and illustrations identifying the product within the container.

It would be advantageous to reliably provide a utensil, such as a spoon, with composite closures for containers, especially for use with single serving sized containers for foodstuffs.

### SUMMARY OF THE INVENTION

The invention concerns a closure for a container. In one preferred embodiment, the closure comprises a central panel formed from paperboard and bounded by a perimeter. The central panel has opposite side surfaces. A plastic skirt is attached to the central panel along the perimeter. The skirt extends substantially perpendicularly to the panel and thereby defines a well on one of the side surfaces. A release coating is preferably applied substantially over the one side surface, but a region is formed on the one side surface wherein the release coating is absent. A plastic utensil is removably attached to the central panel over the region having no release coating.

The utensil may be a spoon, a knife, a fork or other implement. Preferably, the plastic is selected from the group consisting of polypropylene, polyethylene and polystyrene, although other materials are also feasible.

The invention further includes a method of making a closure for a container. As described above, the closure includes a utensil and a plastic skirt surrounding a central panel. The method comprises the steps of:

(A) placing the central panel within a mold;

(B) injecting a plastic resin into the mold, the mold having a mold space defining the skirt and the utensil; and

(C) removing the closure from the mold.

The method may also include the step of adhering the utensil to the central panel.

### BRIEF DESCRIPTION OF THE DRAWINGS

FIG. 1 is a perspective view of a container with a composite closure according to the invention;

FIG. 2 is a top perspective view of the closure shown in FIG. 1; and

FIG. 3 is a bottom perspective view of the closure shown in FIG. 1.

### DETAILED DESCRIPTION OF THE EMBODIMENTS

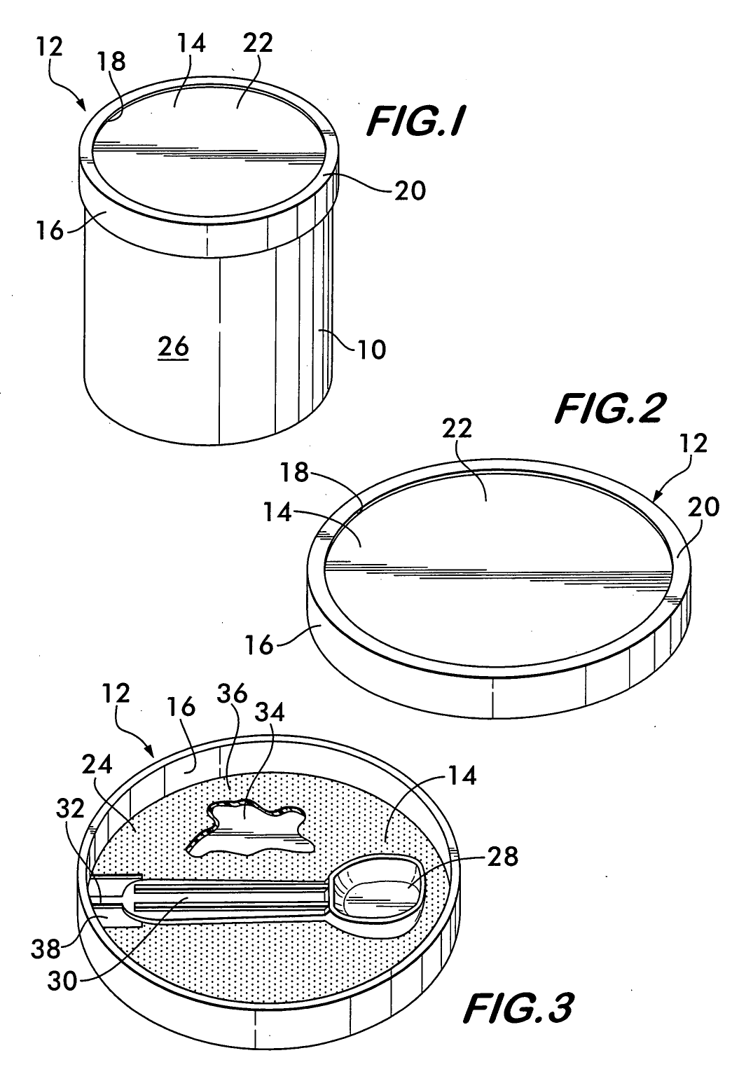

FIG. 1 shows a perspective view of a container having a composite closure 12 according to the invention. Container 10 is preferably a single serving container holding foodstuffs such as ice cream. Closure 12 comprises a central panel 14, preferably formed from paperboard. Paperboard is advantageous because it permits central panel 14 to be printed with multi-color indicia for the display of trademarks, illustrations, and other attention-getting devices to help distinguish the product within the container from among the many others with which it competes on the store shelf.

Central panel 14 is surrounded by a plastic skirt 16 which is attached to the perimeter 18 of the panel. Skirt 16 is sized to engage the container 10 and form a seal between it and the closure 12. Preferably, the composite closure 12 is formed by injection molding in a cavity and core mold. The mold is opened by removing the core from the cavity, and a pre-printed central panel 14 is placed therein. The mold is then closed by inserting the core into the cavity, the cavity and core having a predetermined mold space defining the skirt 16.

Molten plastic is injected into the mold space between the cavity and core to form the skirt 16. A portion of the perimeter 18 of panel 12 extends into the mold space within the mold and is thereby engaged by the molten plastic upon injection. As shown in FIG. 2, the engagement of skirt 16 with perimeter 18 is advantageously accomplished by the use of a flange 20 that projects substantially perpendicularly from skirt 16 onto the outwardly facing surface 22 of central panel 14. The outwardly facing surface 22 is treated so as to be compatible with the plastic forming the flange 20, which adheres to the central panel 14 upon curing. Some plastic resins, such as polypropylene, will adhere directly to paperboard. It is also feasible to use a pre-printed paperboard coated with a thin layer of polypropylene to ensure good adhesion between the flange 20 and the central panel 14. Other plastics, such as polyethylene and polystyrene may also be used to form skirt 16 and flange 20.

FIG. 3 shows a perspective view of the opposite side of the closure 12. Skirt 16 extends away from the central panel 14 substantially perpendicularly to define a well 24 that faces the inside of the container 10 when the closure 12 is mounted thereon to close it. The container 10 is received within well 24, the skirt 16 engaging the sidewall 26 of the container 10 as shown in FIG. 1 to form a seal. The seal may be augmented by attaching a plastic or foil membrane across the opening of the container 10 between the central panel 12 and the container.

With reference again to FIG. 3, a utensil 28 having an elongated handle 30 is molded with the skirt 16. Utensil 28 is positioned within well 24 adjacent to the central panel 14 and will thus be protected on the inside of the container 10 when the closure 12 is in place thereon. In the example shown, the utensil is a spoon, as would be appropriate for a container holding ice cream or yogurt, to be consumed by the purchaser directly from the container. However, the utensil could also be a knife, as would be appropriate if the container contents were, for example, cream cheese to be spread on another food item. The utensil would be a fork if the container held solid food matter. To augment the stiffness of the utensil it is preferred to form it from polypropylene or polystyrene.

The core of the cavity and core mold has a mold space defining the utensil 28. One surface of this mold space is bounded by the central panel 14 when it is placed in the mold. A gate is positioned between the aforementioned mold space defining the skirt 16 and the mold space defining the utensil 28 to provide fluid communication between these spaces, allowing the molten plastic to flow under pressure into both mold spaces to mold both the utensil and the skirt. Sprue 32 is formed in the gate between the mold spaces. The sprue is readily severable for ease of removal of the utensil 28 from the skirt 16.

The inwardly facing surface 34 of central panel 14 preferably has a release coating 36 thereon to prevent the utensil 28 from adhering to the central panel 14 substantially over the length of the utensil upon curing of the plastic resin. If the utensil 28 is allowed to adhere lengthwise to the central panel 14, or even at spaced locations along the utensil's length, it will cause the panel to warp because the plastic comprising the utensil shrinks upon curing. The release coating 36 may comprise a layer of varnish or polyester, which is preferably pre-printed or coated onto the surface 34. Attachment of the utensil 28 to the closure 12 is effected by providing a relatively small region 38 on surface 34 of the central panel 14 that does not have a release coating. Region 38 is preferably positioned at or near the end of handle 30 and allows a portion of the utensil to adhere to the inwardly facing surface 34 upon molding of the utensil and the skirt. This prevents the utensil 28 from becoming detached from the closure 12 during manufacturing, handling and assembly. It also prevents the utensil from contacting the food item within the container during shipment and storage. Significant distortion of the central panel 14 is avoided by attaching the handle 30 to the central panel over a relatively small area substantially adjacent to the skirt 16.

Container closures according to the invention provide a composite closure having a utensil and are advantageously used with single serving containers to allow the food therein to be consumed directly out of the container.

What is claimed is:

1. A method of making a closure for a container, the closure including a utensil and a plastic skirt surrounding a panel, the method comprising:
providing a mold having a mold space that receives said panel and defines said skirt and said utensil;
positioning said panel within said mold space;
injecting molten plastic into said mold space thereby forming said skirt and said utensil, said molten plastic adhering to said panel;
curing said plastic to form said closure; and
removing said closure from said mold.

2. A method according to claim 1, further comprising forming said utensil adjacent to said panel.

3. A method according to claim 2, further comprising coating said panel with a plastic compatible with said plastic injected into said mold to facilitate adherence of said plastic to said panel.

4. A method according to claim 3, further comprising adhering said utensil to said panel.

5. A method according to claim 4, further comprising adhering said utensil to said panel adjacent to said skirt.

6. A method according to claim 4, further comprising coating a portion of said panel with a release coating to prevent said utensil from adhering to said panel substantially along its length.

7. A method according to claim 1, further comprising providing a cavity and core mold.

8. A method according to claim 7, further comprising:
opening said mold by removing said cavity from said core;
positioning said panel within said cavity; and
closing said mold by inserting said cavity into said core.
